(19) United States
(12) Patent Application Publication
(10) Pub. No.: US 2005/0068976 A1
(43) Pub. Date: Mar. 31, 2005

(54) Data transmitting apparatus, data transmitting/receiving system, and data transmitting/receiving method

(75) Inventors: Shigeru Maeda, Kunitachi-shi (JP); Takashi Kokubo, Ome-shi (JP); Kazunobu Konda, Tokyo (JP); Hideki Ohkita, Kunitachi-shi (JP)

Correspondence Address: FOLEY & LARDNER, 2029 CENTURY PARK EAST, SUITE 3500, LOS ANGELES, CA, 90067, US

(73) Assignee: Kabushiki Kaisha Toshiba

(21) Appl. No.: 10/816,349

(22) Filed: Apr. 1, 2004

(30) Foreign Application Priority Data
Sep. 30, 2003 (JP) 2003-342328

(51) Int. Cl. H04L 12/54

(52) U.S. Cl. 370/428

(57) ABSTRACT

A data transmitting apparatus includes a stream input unit which inputs digital-encoded stream data, a buffer which executes buffering of the inputted stream data, a converting unit which converts information including the stream data on which buffering has been executed by the buffer, into a file according to a capacity of the buffer, and a transmitting unit which transmits the file converted by the converting unit.

### CROSS-REFERENCE TO RELATED APPLICATIONS

This application is based upon and claims the benefit of priority from the prior Japanese Patent Application No. 2003-342328, filed Sep. 30, 2003, the entire contents of which are incorporated herein by reference.

### BACKGROUND OF THE INVENTION

1. Field of the Invention

The present invention relates to a data transmitting apparatus, a data transmitting/receiving system, and a data transmitting/receiving method, and more particularly, to a data transmitting/receiving system which can transmit and receive appropriate stream data corresponding to a request for special playback or the like.

2. Description of the Related Art

In recent years, transmitting and receiving of digital stream data via a network have come to be executed. For example, when normal playback or special playback of contents is requested from a user terminal to a server apparatus, the server apparatus executes transmission, to the user terminal, of the corresponding digital stream data in accordance with the request. In Jpn. Pat. Appln. KOKAI Publication No. 2002-10184, there is disclosed a system in which image data is transmitted to a user terminal via a network from an image management apparatus in accordance with a request for playback of image data, or the like, from the user terminal.

Further, there are various types of communication protocols, and in particular, a form in which contents are distributed from an HTTP server to user terminals via a network such as Internet or the like by using HTTP (Hypertext Transfer Protocol) has increased. Therefore, it is probable that, in the future, a form in which the use of http for normal playback and special playback of digital stream data will become more common.

However, there is a problem in that the size of data transmitted from a server apparatus cannot be known from a user terminal side. As a result, an input buffer having a relatively large capacity must be provided in order to normally always be able to receive the data with a resulting increase in cost or the like. In particular, when special playback such as fast-forward playback, rewind playback, or the like is executed, complicated processing in which a buffer having a large capacity must be provided at the user terminal side, and the necessary frame data are retrieved from the stream data in the buffer, and decoded.

### BRIEF SUMMARY OF THE INVENTION

Embodiments of the present invention may provide a data transmitting apparatus, a data transmitting/receiving system, and a data transmitting/receiving method that enable data transmission by an input buffer having a relatively small capacity.

According to one aspect of the present invention, there is provided a data transmitting apparatus comprising a stream input unit which inputs digital-encoded stream data; a buffer which executes buffering of the inputted stream data; a converting unit which converts information including the stream data on which buffering has been executed by the buffer, into a file according to a capacity of the buffer; and a transmitting unit which transmits the file converted by the converting unit.

According to another aspect of the present invention, there is provided a data transmitting/receiving system, comprising a data transmitting apparatus; and a data receiving apparatus, the data transmitting apparatus including a stream input unit which inputs digital-encoded stream data, a first buffer which executes buffering of the inputted stream data, a converting unit which converts information including the stream data on which buffering has been executed by the first buffer, into a file according to a capacity of the buffer, and a transmitting unit which transmits the file converted by the converting unit, the data receiving apparatus including a second buffer which inputs the file transmitted from the data transmitting apparatus, and a playback processing unit which plays back stream data from the file inputted to the second buffer.

According to still another aspect of the present invention, there is provided a data transmitting/receiving method of executing transmission/reception of data between a data transmitting apparatus and a data receiving apparatus, the method comprising requesting playback from the data receiving apparatus to the data transmitting apparatus; and converting digital-encoded stream data into stream data suitable for the playback requested, in the data transmitting apparatus, and storing the stream data in a buffer, converting information including the stream data on which buffering has been executed by the buffer, into a file according to a capacity of the buffer, and transmitting the converted file from the data transmitting apparatus to the data receiving apparatus.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a data transmitting apparatus according to a first embodiment of the present invention;

FIG. 2 is a diagram for explanation of the details of data processed by an output buffer, a buffer converting unit, and an HTML converting unit;

FIG. 3 is a block diagram showing a configuration of a data receiving apparatus;

FIG. 4 is a view showing an example in which a list of contents relating to resources is converted into an HTML file by the HTML converting unit;

FIG. 5 is a diagram of the flow of the processing when the data receiving apparatus requests, of the data transmitting unit, normal playback of certain contents;

FIG. 6 is a diagram of the flow of the processing when the data receiving apparatus requests, of the data transmitting unit, fast-forward playback of the same contents;

FIG. 7 is a block diagram showing a configuration of a data transmitting apparatus according to a second embodiment of the present invention;

FIG. 8 is a diagram showing the flow of the processing when a data receiving apparatus requests, of the data transmitting unit, normal playback of certain contents;

FIG. 9 is a diagram showing the flow of the processing when the data receiving apparatus requests, of the data transmitting unit, fast-forward playback of the same contents;

FIG. 10 is a block diagram showing a modified example of the configuration of the data transmitting apparatus according to the first embodiment; and

FIG. 11 is a block diagram showing a modified example of the configuration of the data transmitting apparatus according to the second embodiment.

### DETAILED DESCRIPTION OF THE INVENTION

Embodiments of the present invention will be described below with reference to the drawings.

(First Embodiment)

A data transmitting/receiving system according to the present embodiment of the present invention includes a data transmitting apparatus 1 and a data receiving apparatus 2.

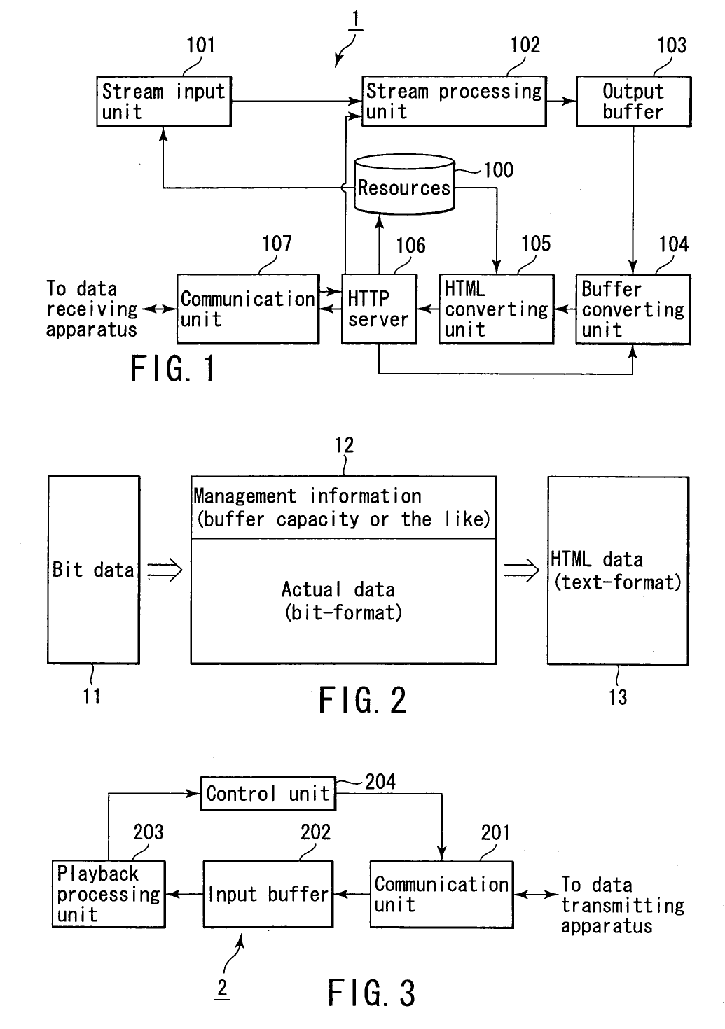

FIG. 1 is a block diagram showing a configuration of the data transmitting apparatus according to a first embodiment of the present invention.

A storage unit 100 has a storage medium such as an HDD or a DVD, and stores various types of data serving as resources in the data transmitting apparatus. Here, the resources includes encoded digital stream data, information requested for the operations of the data transmitting apparatus, a list of contents in the data transmitting apparatus, and the like.

A stream input unit 101 inputs, for example, the digital stream data stored in the storage unit 100.

A stream processing unit 102 processes the stream data inputted by the stream input unit 101, and outputs the data to an output buffer 103. In the present embodiment, a case in which a structure of the stream is based on a MPEG2 PS format, a GOP (group of picture) structure thereof is “IBBPBBPBBPBBPBB” will be explained.

When normal playback is executed, the stream processing unit 102 outputs all of the frames of I, B, P. The stream processing unit 102 outputs, for example, only I frames and P frames from a GOP structure when two-times faster playback is executed, and outputs only I frames in a case of fifteen-times faster playback. In a case of thirty-times faster playback, the stream processing unit 102 executes processing such as extracting only I frames and skipping every other GOP or the like. Further, in a case of rewind playback, the stream processing unit 102 executes processing such as extracting only I frames from every GOP while tracing backward.

The output buffer 103 temporarily executes buffering of the stream data processed by the stream processing unit 102. Generally, it is usually the case that the output buffer is sufficiently small as compared with the size of the entire stream which is played back. This is because, while the stream which is played back is, for example, a recorded TV program, a landscape photographed by a video camera, or the like, the output buffer holds only a relatively small portion thereof. In the present embodiment, such a general output buffer is used. Therefore, a capacity of the output buffer 103 is smaller than a capacity of an input buffer at the data receiving apparatus 2 which will be described later.

Note that, there are no particular limitations on the method of configuring the output buffer 103. For example, a memory of a given region may be applied thereto, or a circulating buffer, an FIFO, or the like may be applied thereto. Further, it may be a form such that a plurality of buffers, such as double-buffers and triple buffers, are provided, and only one buffer is used at each point in time in the time sequence. Thus, the plural buffers may be used, one after the other.

A buffer converting unit 104 converts information including the stream data on which buffering has been executed by the output buffer 103, into a file format, in accordance with the capacity (or the size) of the output buffer 103. Note that there are no particular limitations on the method of configuring the buffer converting unit 104. For example, when the output buffer 103 is a memory of a given region, a file may be produced by using the output buffer 103 as a configuration corresponding to a RAM disc, and further, when the output buffer 103 is an FIFO, a file may be produced by using the output buffer 103 as a configuration corresponding to a virtual file system.

An HTML (Hyper Text Markup Language) converting unit 105 converts the resources in the data transmitting apparatus 1 into HTML files in order to exhibit the resources in the data receiving apparatus 2. Namely, the HTML converting unit 105 converts information converted into a file format by the buffer converting unit 104, and moreover, executes processing in which a list of contents is converted into an HTML file on the basis of the resources stored in the storage unit 100, or the like.

An HTTP server 106 executes all of the processings relating to information which should be communicated in HTTP between the data transmitting apparatus 1 and the external data receiving apparatus 2. For example, the HTTP server 106 controls respective elements in the data transmitting apparatus 1 in accordance with various requests (a request for transmission of the list of contents, a request for normal playback, a request for special playback, and the like) from the data receiving apparatus 2, and transmits the HTML file converted by the HTML converting unit 106, to the data receiving apparatus 2 which is the source of the request via a communication unit 107. Note that there can be “fast-forward playback”, “rewind playback”, and “slow-speed playback” as examples of the “special playback”.

The communication unit 107 corresponds to an HTTP communication device complying to HTTP, and executes data communication relating to operating information, stream data, and the like, with the data transmitting apparatus 2 via a network. Note that there are no particular limitations on the medium and the method for use in the network communication.

Here, details of the data processed by the output buffer 103, the buffer converting unit 104, and the HTML converting unit 105 will be described with reference to FIG. 2.

The stream data on which buffering is executed by the output buffer 103 is a bit-format data 11. In the buffer converting unit 104, information including bit-format stream data is converted into a file 12. In this case, in the file 12, in addition to actual data corresponding to the bit-format stream data, related management information is included. As this related management information, a buffer capacity (or size), directory information, a file name, a physical address on the memory, and the like are defined. In the HTML converting unit 105, the above-described file 12 is converted into an HTML file 13 in text-format HTML data.

FIG. 3 is a block diagram showing a configuration of the data receiving apparatus 2 according to the first embodiment. Note that the configuration shown in FIG. 3 is applied to respective embodiments, as well, which will be described later.

A communication unit 201 corresponds to an HTTP communication device complying to HTTP, and executes data communication relating to operating information, stream data, or the like, with the data transmitting apparatus 1 via a network. Note that there are no particular limitations on the medium and the method for use in the network communication.

An input buffer 202 temporarily executes buffering of HTML file-format stream data received by the communication unit 201, or the like. It suffices that the capacity of the input buffer 202 is greater than or equal to the capacity of the output buffer 103 at the data transmitting apparatus 1 side, and a buffer having a relatively small capacity can be applied.

A playback processing unit 203 executes playback of the HTML file-format stream data on which the buffering has been executed by the input buffer 202.

A control unit 204 controls the respective elements in the data receiving apparatus 2, and executes processing relating to information which should be communicated in HTTP between the data receiving apparatus 2 and the data transmitting apparatus 1. For example, the control unit 204 makes various requests (a request for transmission of the list of contents, a request for normal playback, a request for special playback, and the like) with respect to the data transmitting apparatus 1, and controls playback-processing of various data transmitted from the data transmitting apparatus 1.

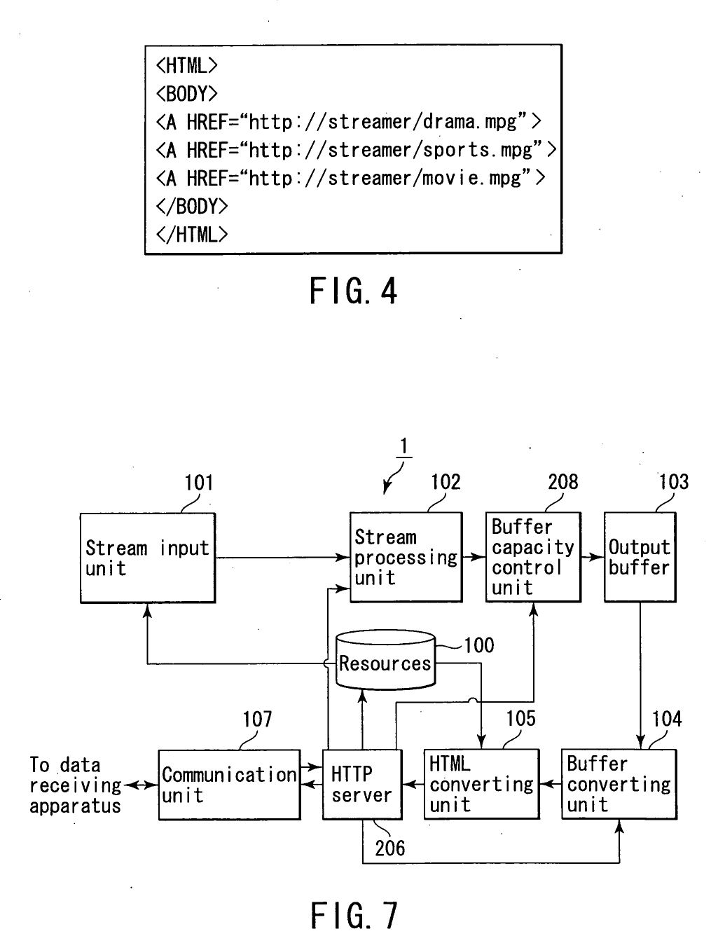

Next, an example in which the list of contents relating to the resources (the bit data 11 of FIG. 2) is converted into an HTML file (the HTML data 13 of FIG. 2) by the HTML converting unit 105 in the data transmitting apparatus 1, will be shown with reference to FIG. 4. In the illustrated example, as the list of contents relating to the resources of the data transmitting apparatus 1, are shown “drama.mpg”, “sports.mpg”, and “movie.mpg”. Here, the host name of the data transmitting apparatus 1 is “streamer”.

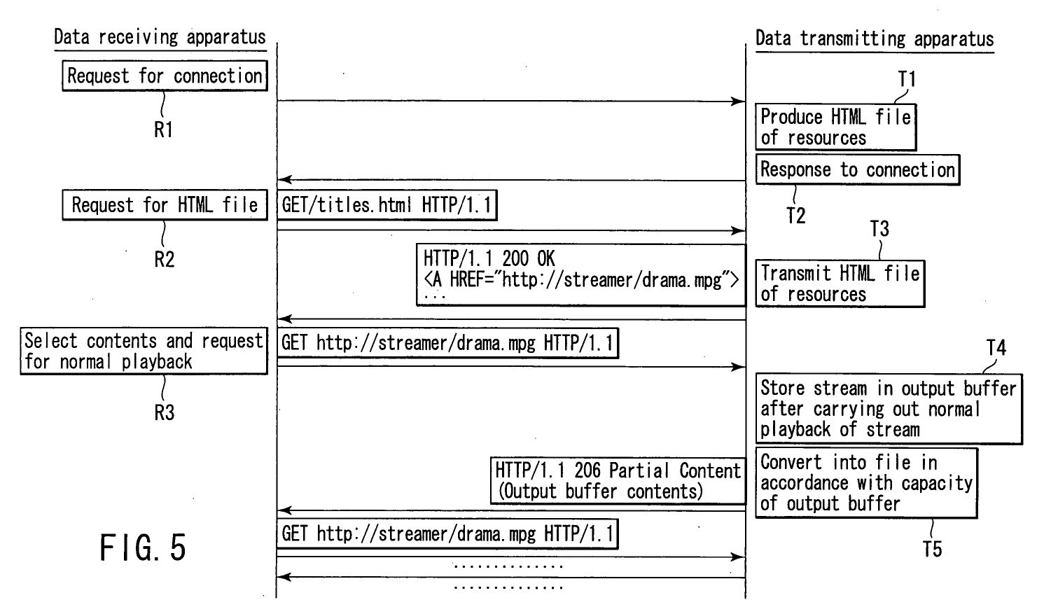

Next, an example of a case in which the data receiving apparatus 2 requests, of the data transmitting apparatus 1, normal playback of certain contents, will be described with reference to FIG. 5.

First, the data receiving apparatus 2 selects the data transmitting apparatus 1 at the other end of the connection, and makes a request for connection with respect to the data transmitting apparatus 1 (step R1). As information requested for the request for connection, there are an IP address, a port number, and the like. Note that there are no particular limitations on the method of selecting the data transmitting apparatus 1 at the other end of the connection.

When the request for connection is executed by the data receiving apparatus 2, the data transmitting apparatus 1 converts the information of the resources in the data transmitting apparatus 1 into an HTML file by the HTML converting unit 105 (step T1). An example of the converted HTML file is shown in FIG. 4. In FIG. 4, it is supposed that the host name of the data transmitting apparatus 1 is “streamer”, and the HTML file simply shows only the list of contents in the data transmitting apparatus 1.

After the HTML file is produced, the data transmitting apparatus 1 returns a connection response to the data receiving apparatus 2 via the communication unit 107 (step T2).

The data receiving apparatus 2 is connected to the data transmitting apparatus 1, and thereafter, the data receiving apparatus 2 requests the list of contents of the data transmitting apparatus 1 by using an information requesting method called HTTP GET (hereinafter the HTTP GET method) (step R2). The data transmitting apparatus 1 which received the request for the list of contents from the data transmitting apparatus 2 processes the HTTP GET method at the HTTP server 106, and transmits the HTML file produced in step T1 to the data receiving apparatus 2 via the communication unit 107 (step T3).

The data receiving apparatus 2 having acquired the HTML file selects the contents for which playback is desired among the list of contents of the data transmitting apparatus 1, and requests stream data of a capacity within the capacity which can be stored in the input buffer 202 of the data receiving apparatus 2 by using an HTTP Range GET method (step R3). The HTTP Range GET method is a standard protocol of HTTP1.1 and is described, in RFC 2616.

The data transmitting apparatus 1 having received the HTTP Range GET method from the data receiving apparatus 2 via the communication unit 107 processes this request at the HTML server 106. The HTML server 106 requests, of the stream processing unit 102, normal playback of the designated contents in order to read the file which is requested from the data receiving apparatus 2.

The stream processing unit 102 having received the request for normal playback of the designated contents outputs the digital stream data inputted from the stream input unit 101 as is to the output buffer 103 (step T4).

The stream data stored in the output buffer 103 is converted into a file which is requested from the HTTP server 106 by the buffer converting unit 104 (step T5). At this time, the file size is the output buffer size.

The HTTP server 106 makes the contents of the output buffer 103 converted into the file be an HTML file, and transmits it to the data receiving apparatus 2 side.

The data receiving apparatus 2 having acquired the HTML file which the data receiving apparatus 2 requested, plays back the acquired stream data, and acquires the following stream data by the HTTP Range GET again at an appropriate point in time, and continues to play back the data.

Next, an example of a case in which the data receiving apparatus 2 requests, of the data transmitting apparatus 1, fast-forward playback of the same contents.

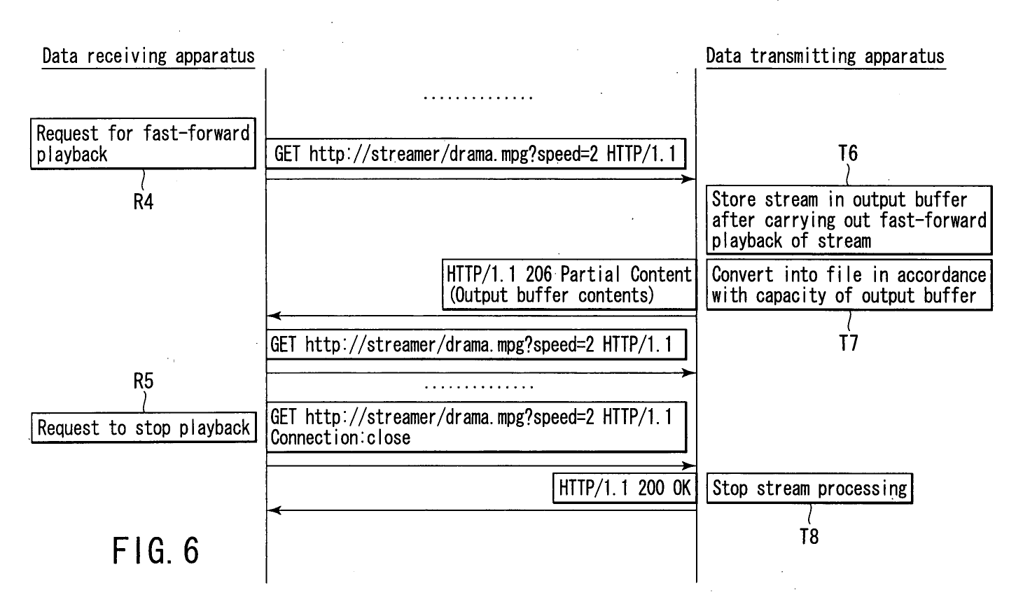

The data receiving apparatus 2 requests, of the server, fast-forward playback of the same contents by a method called the HTTP Range GET (step R4). At this time, for example, the designation of a speed is executed using a value of a parameter “speed” being designated. Here, as shown in FIG. 6, it is supposed that 2 is designated as the value of the parameter “speed”, and two-times faster forward playback is requested.

The data transmitting apparatus 1 having received the HTTP Range GET method from the data receiving apparatus 2 via the communication unit 107 processes this request at the HTML server 106. The HTTP server 106 requests, of the stream processing unit 102, two-times faster forward playback of the designated contents in order to read the file requested from the data receiving apparatus 2.

The stream processing unit 102 having received the request for fast-forward playback of the designated contents converts the digital stream data inputted from the stream input unit 101 into stream data suitable for the type of the designated special playback, and outputs it to the output buffer 103 (step T6).

The stream data stored in the output buffer 103 is converted into a file which is requested from the HTTP server 106 by the buffer converting unit 104 (step T7). At this time, the file size is the output buffer size.

The HTTP server 106 takes the contents of the output buffer 103 converted into the file be an HTML file, and transmits it to the data receiving apparatus 2 side.

The data receiving apparatus 2 having acquired the HTML file which the data receiving apparatus 2 requested, plays back the acquired stream data, and acquires the following stream data by the HTTP Range GET again at an appropriate point in time, and continues to play back the data. At this time, because the data transmitting apparatus 1 executes fast-forward playback processing of the acquired stream data at a speed designated in advance, it suffices that the data receiving apparatus 2 decode the acquired stream data as is at the playback processing unit 203, and display it.

When the data receiving apparatus 2 stops playback of the contents, a request header “Connection:” is added to the HTTP GET method, and it is transmitted to the data transmitting apparatus 1 (step R5).

The data transmitting apparatus 1 having received the request to stop playback stops processing of the stream data by instructing the stream processing unit 102 a playback stop (step T8), and cut off the connection with the data receiving apparatus 2.

In this way, in the first embodiment, the contents of the output buffer at the data transmitting apparatus side are converted into the file, and transmitted to the data transmitting apparatus side, whereby the received data size can be limited to at least the size of the output buffer. Further, the data receiving apparatus can acquire stream data corresponding to a type of designated special playback in unit of a relatively small capacity by the HTTP Range GET method. Therefore, in the data receiving apparatus having an input buffer whose capacity is relatively small as well, special playback is possible.

(Second Embodiment)

FIG. 7 is a block diagram showing a configuration of a data transmitting apparatus according to a second embodiment of the present invention. Elements which are in common with the above-described first embodiment (refer to FIG. 1) are denoted by the same reference numerals, and detailed description thereof will be omitted.

The data transmitting apparatus shown in

FIG. 7 is an apparatus in which a buffer capacity control unit 208 is added the data transmitting apparatus shown in FIG. 1. The buffer capacity control unit 208 is connected between the output side of the stream processing unit 102 and the input side of the output buffer 103, and variably controls the capacity of the output buffer 103 in accordance with an instruction from an HTTP server 206.

Further, the HTTP server 206 executes the same processing which the above-described HTTP server 106 executes, and moreover, executes processing of transmitting an instruction to the buffer capacity control unit 208 such that the buffer capacity of the output buffer 103 is limited to a value designated from the data receiving apparatus 2 side.

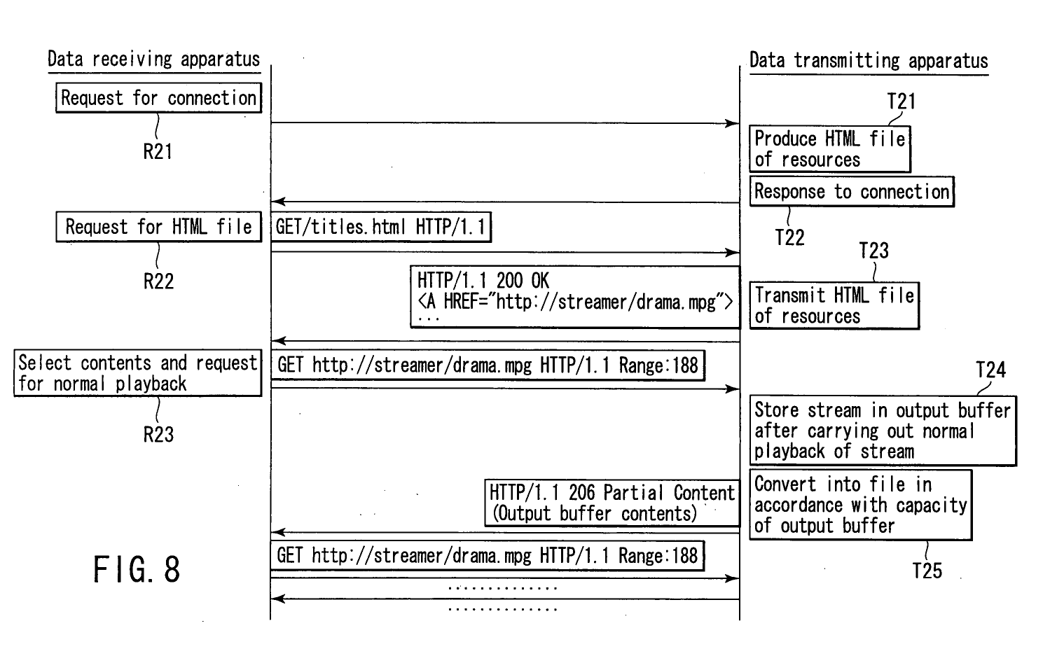

Next, an example of a case in which the data receiving apparatus 2 requests, of the data transmitting apparatus 1, normal playback of certain contents, will be described with reference to FIG. 8.

First, the data receiving apparatus 2 selects the data transmitting apparatus 1 at the other end of the connection, and makes a request for connection with respect to the data transmitting apparatus 1 (step R21). As information requested for the request for connection, there are an IP address, a port number, and the like. Note that there are no particular limitations on the method of selecting the data transmitting apparatus 1 at the other end of the connection.

When the request for connection is executed by the data receiving apparatus 2, the data transmitting apparatus 1 converts the information of the resources in the data transmitting apparatus 1 into an HTML file by the HTML converting unit 105 (step T21).

After the HTML file is produced, the data transmitting apparatus 1 returns a connection response to the data receiving apparatus 2 via the communication unit 107 (step T22).

The data receiving apparatus 2 is connected to the data transmitting apparatus 1, and thereafter, the data receiving apparatus 2 requests the list of contents of the data transmitting apparatus 1 by using the HTTP GET method (step R22).

The data transmitting apparatus 1 which received the request for the list of contents from the data transmitting apparatus 2 processes the HTTP GET method at the HTTP server 206, and transmits the HTML file produced in step T21 to the data receiving apparatus 2 via the communication unit 107 (step T23).

The data receiving apparatus 2 having acquired the HTML file selects the contents for which playback is desired among the list of contents of the data transmitting apparatus 1, and requests stream data by using an HTTP Range GET method. At this time, a stream data size to be acquired is designated by adding a request header “Range:” (step R23). Provided that the size of the input buffer of the data receiving apparatus 2 is 188, this value is designated to the request header “Range:” as illustrated, whereby the size of the data to be acquired can be limited to the input buffer size of the data receiving apparatus 2.

The data transmitting apparatus 1 having received the HTTP Range GET method from the data receiving apparatus 2 via the communication unit 107 processes this request at an HTML server 206. The HTML server 206 requests, of the stream processing unit 102, normal playback of the designated contents in order to read the file which is requested from the data receiving apparatus 2.

The stream processing unit 102 having received the request for normal playback of the designated contents outputs the digital stream data inputted from the stream input unit 101 as is, to the buffer capacity control unit 208. The buffer capacity control unit 208 outputs the stream data to the output buffer 103 while limiting the buffer capacity to a value which the data receiving apparatus 2 designated at the request header “Range:” (step T24).

The stream data stored in the output buffer 103 is converted into a file which is requested from the HTTP server 206, by the buffer converting unit 104 (step T25). At this time, the file size is the size which the data receiving apparatus 2 designated at the request header “Range:”.

The HTTP server 206 takes the contents of the output buffer 103 converted into the file be an HTML file, and transmits it to the data receiving apparatus 2 side.

The data receiving apparatus 2 having acquired the HTML file which the data receiving apparatus 2 requested, plays back the acquired stream data, and acquires the following stream data by the HTTP Range GET again at an appropriate point in time, and continues to play back the data.

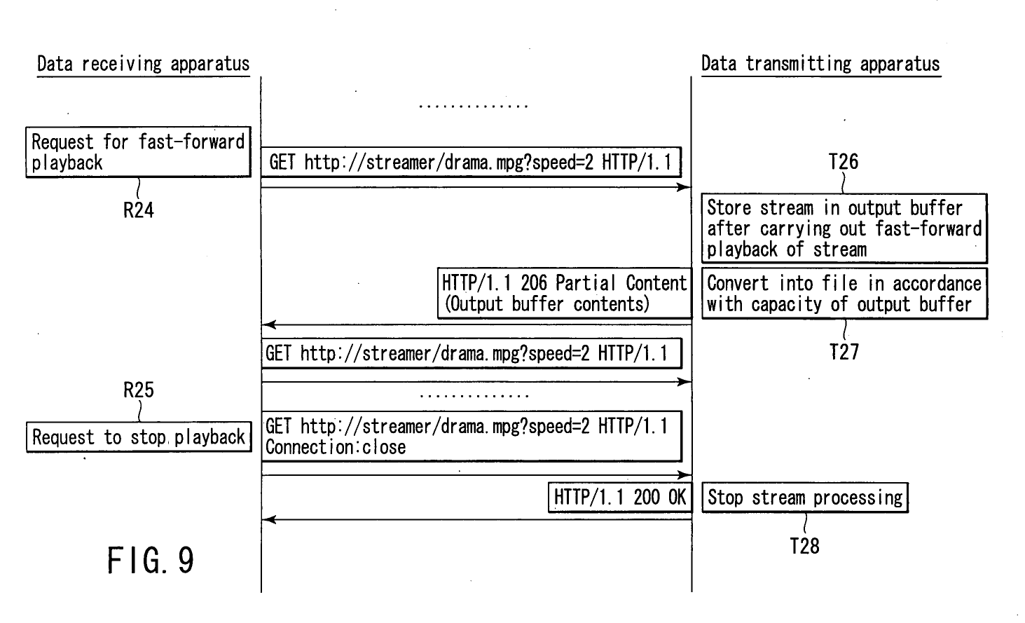

Next, an example of a case in which the data receiving apparatus 2 requests, of the data transmitting apparatus 1, fast-forward playback of the same contents, will be described with reference to FIG. 9.

The data receiving apparatus 2 requests, of the server, fast-forward playback of the same contents by the HTTP Range GET (step R24). At this time, a stream data size to be acquired is designated by adding the request header “Range:” as shown in FIG. 8. Further, for example, designation of a speed is executed by designating a value of the parameter “speed”. As shown in FIG. 9, it is supposed that 2 is designated as the value of the parameter “speed”, and two-times faster forward playback is requested.

The data transmitting apparatus 1 having received the HTTP Range GET method from the data receiving apparatus 2 via the communication unit 107, processes this request at the HTML server 206. The HTTP server 206 requests, of the stream processing unit 102, two-times faster forward playback of the designated contents in order to read the file which is requested from the data receiving apparatus 2.

The stream processing unit 102 having received the request for fast-forward playback of the designated contents converts the digital stream data inputted from the stream input unit 101 into the stream data suitable for the type of designated special playback, and outputs it as is to the buffer capacity control unit 208. The buffer capacity control unit 208 outputs the stream data to the output buffer 103 while limiting the buffer capacity to the value which the data receiving apparatus 2 designated at the request header “Range:” (step T26).

The stream data stored in the output buffer 103 is converted into a file which is requested from the HTTP server 206, by the buffer converting unit 104 (step T27). At this time, the file size is the size which the data receiving apparatus 2 designated at the request header “Range:”.

The HTTP server 206 makes the contents of the output buffer 103 converted into the file be an HTML file, and transmits it to the data receiving apparatus 2 side.

The data receiving apparatus 2 having acquired the HTML file which the data receiving apparatus 2 requested, plays back the acquired stream data, and acquires the following stream data by the HTTP Range GET again at an appropriate point in time, and continues to play back the data. At this time, because the data transmitting apparatus 1 executes fast-forward playback processing of the acquired stream data at a speed designated in advance, it suffices that the data receiving apparatus 2 decode the acquired stream data as is at the playback processing unit 203, and display it.

When the data receiving apparatus 2 stops the playback of the contents, a request header “Connection:” is added to the HTTP GET method, and it is transmitted to the data transmitting apparatus 1 (step R25).

The data transmitting apparatus 1 having received the request to stop playback, stops processing of the stream data by instructing the stream processing unit 102 a playback stop (step T28), and cuts off the connection with the data receiving apparatus 2.

In this way, in the second embodiment, in addition to the effects which can be obtained in the first embodiment described above, due to the data receiving apparatus making the value of the Range: parameter of the HTTP Range GET be the capacity of the input buffer, the received stream data can be suppressed to the capacity of the input buffer of the data receiving apparatus.

(Modified Example of First Embodiment)

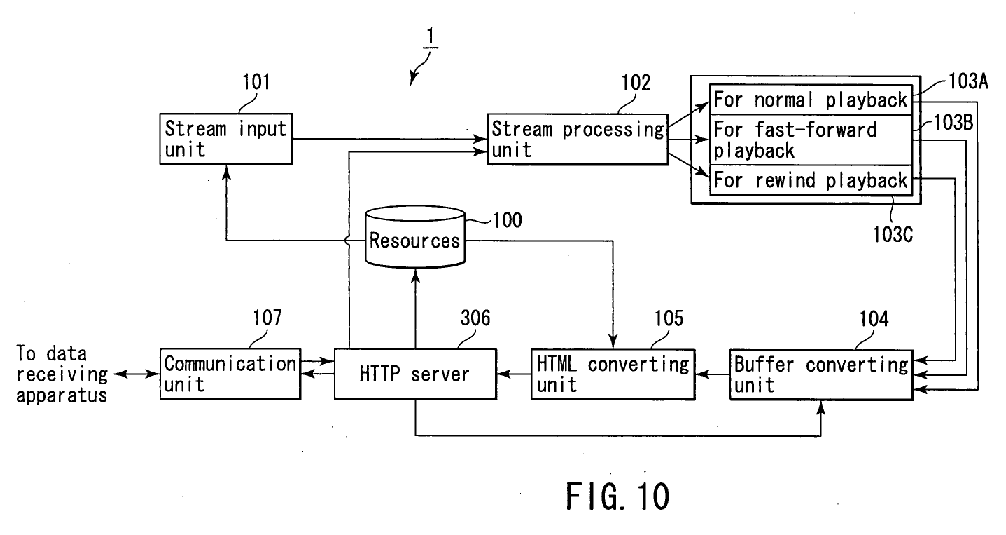

FIG. 10 is a block diagram showing a modified example of the configuration of the data transmitting apparatus according to the first embodiment. Elements which are in common with the above-described first embodiment (refer to FIG. 1) are denoted by the same reference numerals, and detailed description thereof will be omitted.

A data transmitting apparatus shown in

FIG. 10 has a plurality of output buffers 103 shown in FIG. 1. In this case, the respective output buffers are, for example, a “normal playback buffer 103A”, a “fast-forward playback buffer 103B”, and a “rewind playback buffer 103C”.

Further, when different types of requests-for-playback are requested from the plurality of data receiving apparatuses 2, an HTTP server 306 controls the stream processing unit 102 so as to output the stream data on which the stream processing unit 102 respectively processed, to the corresponding buffers.

In accordance therewith, a playback mode which is independent for each buffer can be realized, and requests from the plurality of data receiving apparatuses 2 can be handled.

(Modified Example of Second Embodiment)

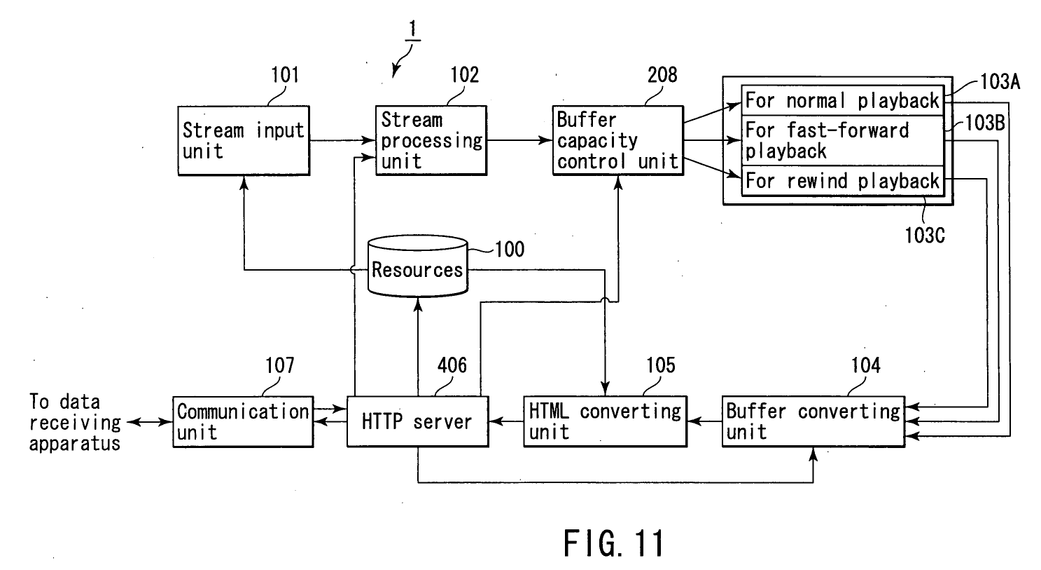

FIG. 11 is a block diagram showing a modified example of the configuration of the data transmitting apparatus according to the second embodiment. Elements which are in common with the above-described second embodiment (refer to FIG. 7) are denoted by the same reference numerals, and detailed description thereof will be omitted.

A data transmitting apparatus shown in

FIG. 11 has the plurality of output buffers 103 shown in FIG. 7. In this case, the respective output buffers are, for example, a “normal playback buffer 103A”, a “fast-forward playback buffer 103B”, and a “rewind playback buffer 103C”.

Further, when different types of requests-for-playback are requested from the plurality of data receiving apparatuses 2, an HTTP server 406 controls the stream processing unit 102 and the buffer capacity control unit 208 such that stream data on which the stream processing unit 102 respectively processed are respectively limited in the capacities thereof at the buffer capacity control unit 208, and thereafter, are outputted to the corresponding buffers.

In accordance therewith, a playback mode which is independent for each buffer can be realized, and requests from the plurality of data receiving apparatuses 2 can be handled.

As described above in detail, according to the present invention, it is possible to enable data transmission by an input buffer having a relatively small capacity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A data transmitting apparatus comprising:
a stream input unit which inputs digital-encoded stream data;
a buffer which executes buffering of the inputted stream data;
a converting unit which converts information including the stream data on which buffering has been executed by the buffer, into a file according to a capacity of the buffer; and
a transmitting unit which transmits the file converted by the converting unit.

2. The data transmitting apparatus according to claim 1, further comprising a buffer capacity control unit which variably controls the capacity of the buffer.

3. The data transmitting apparatus according to claim 1, wherein the buffer includes a first buffer which executes buffering of stream data relating to normal playback, and a second buffer which executes buffering of stream data relating to special playback.

4. A data transmitting/receiving system, comprising:
a data transmitting apparatus; and
a data receiving apparatus, the data transmitting apparatus including:
a stream input unit which inputs digital-encoded stream data,
a first buffer which executes buffering of the inputted stream data,
a converting unit which converts information including the stream data on which buffering has been executed by the first buffer, into a file according to a capacity of the buffer, and
a transmitting unit which transmits the file converted by the converting unit,
the data receiving apparatus including:
a second buffer which inputs the file transmitted from the data transmitting apparatus, and
a playback processing unit which plays back stream data from the file inputted to the second buffer.

5. The data transmitting/receiving system according to claim 4, wherein the capacity of the first buffer is smaller than a capacity of the second buffer.

6. The data transmitting/receiving system according to claim 4, wherein the data transmitting apparatus further includes a buffer capacity control unit which variably controls the capacity of the first buffer.

7. The data transmitting/receiving system as recited in claim 4 wherein said data receiving unit is operative for transmitting to said data transmitting apparatus information specifying the size of said second buffer.

8. The data transmitting/receiving system as recited in claim 7, wherein said data transmitting apparatus is responsive to said size information to control the content of said first buffer to be less that or equal to the size of said first buffer as designated by said size information.

9. The data transmitting/receiving system as recited in claim 6 wherein said data receiving unit is operative for transmitting to said data transmitting apparatus information specifying the size of said second buffer.

10. The data transmitting/receiving system as recited in claim 9 wherein said buffer capacity control unit is responsive to said size information to control the content of said first buffer to be less that or equal to the size of said first buffer as designated by said size information.

11. The data transmitting/receiving system according to claim 4, wherein said data receiving apparatus includes a communication unit and transmits a speed request to said data transmitting apparatus designating a speed at which the file is requested to be sent to said data receiving apparatus.

12. The data transmitting/receiving system according to claim 4, wherein said data receiving apparatus includes a communication unit and transmits a speed special playback request to said data transmitting apparatus designating a special playback at which the file is requested to be sent to said data receiving apparatus.

13. The data transmitting/receiving system according to claim 4, wherein the first buffer includes one buffer which executes buffering of stream data relating to normal playback and another buffer which executes buffering of stream data relating to special playback.

14. A data transmitting/receiving method of executing transmission/reception of data between a data transmitting apparatus and a data receiving apparatus, the method comprising:
requesting playback from the data receiving apparatus to the data transmitting apparatus; and
converting digital-encoded stream data into stream data suitable for the playback requested, in the data transmitting apparatus, and storing the stream data in a buffer, converting information including the stream data on which buffering has been executed by the buffer, into a file according to a capacity of the buffer, and transmitting the converted file from the data transmitting apparatus to the data receiving apparatus.

15. The data transmitting/receiving method according to claim 14, further comprising variably controlling the capacity of the buffer.

16. The data transmitting/receiving method according to claim 14, wherein the buffer is arranged to include a first buffer which executes buffering of stream data relating to normal playback and a second buffer which executes buffering of stream data relating to special playback.

17. The data transmitting/receiving method according to claim 14 wherein the step of requesting playback from the data receiving apparatus to the data transmitting apparatus includes specifying a speed parameter by said receiving apparatus.

18. The data transmitting/receiving method according to claim 14 wherein the step of requesting playback from the data receiving apparatus to the data transmitting apparatus includes specifying a special playback parameter by said receiving apparatus.
